(19) United States
(12) Patent Application Publication
(10) Pub. No.: US 2015/0345389 A1
(43) Pub. Date: Dec. 3, 2015

(54) Multi Stage Air Flow Management

(71) Applicant: UNITED TECHNOLOGIES CORPORATION, Hartford, CT (US)

(72) Inventor: Pellegrino J. Pisacreta, Newtown, CT (US)

(21) Appl. No.: 14/759,292

(22) PCT Filed: Dec. 18, 2013
(86) PCT No.: PCT/US2013/076017

§ 371 Date: Jul. 6, 2015

Related U.S. Application Data
(60) Provisional application No. 61/769,530, filed on Feb. 26, 2013.

(51) Int. Cl. F02C 7/04

(52) U.S. Cl. CPC F02C 7/04

(57) ABSTRACT

In accordance with one aspect of the disclosure, a multi stage air flow management system for a gas turbine engine is disclosed. The system may include an inlet provided in a nacelle of a gas turbine engine. A first passage may communicate a flow of air from the inlet to a first engine component of the gas turbine engine and a second passage may communicate a flow of air to a second engine component of the gas turbine engine.

### CROSS-REFERENCE TO RELATED APPLICATION

This application is a US National Stage under 35 USC §371 of International Patent Application No. PCT/US13/76017 filed on Dec. 18, 2013 based on U.S. Provisional Patent Application Ser. No. 61/769,530 filed on Feb. 26, 2013.

### FIELD OF THE DISCLOSURE

The present disclosure generally relates to gas turbine engines and, more specifically, to multi stage air flow management systems for gas turbine engines.

### BACKGROUND OF THE DISCLOSURE

Gas turbine engines generally have a plurality of axially aligned components including a fan, a compressor section, a combustor, and a turbine section. The fan, positioned at a forward end of the engine, rotates to draw in and accelerate ambient air. Some of the accelerated air flows to the compressor section, as a core flow, where the air is compressed and then flows to the combustor. At the combustor, the compressed air is mixed with fuel and combusted to form an exhaust. The exhaust expands from the combustor through the turbine section, causing turbines of the turbine section to rotate, and then flowing out of the engine at an aft end of the engine. The rotation of the turbines drives the rotation of the fan and compressors by way of a shaft, or a plurality of concentrically mounted shafts in the case of a multi-spool engine. It can therefore be seen that once this process has begun it is self sustaining.

A nacelle encases the engine and includes an inner wall immediately surrounding the engine and an outer wall spaced apart from and surrounding the inner wall. The inner and outer walls of the nacelle cooperate to form an air passage therebetween. Some of the air accelerated by the fan bypasses the other engine components and flows through this air passage as a bypass air flow. This bypass air flow is responsible for the majority of the thrust provided by the engine. In some prior art engines an intake, such as a plurality of holes communicating through the inner wall of the nacelle or a ram scoop, is provided to utilize some of the bypass air flow as a cooling flow for some engine or other aircraft components, such as an air-oil cooler or an auxiliary power unit. One such intake is described in the U.S. Pat. No. 5,655,359. The described intake is a ram scoop which allows air to flow to an auxiliary power unit and then back into the atmosphere.

A system or intake that draws air from the bypass air flow or the atmosphere for use in multiple applications before being discharged is needed.

### SUMMARY OF THE DISCLOSURE

In accordance with one aspect of the disclosure, a multi stage air flow management system for a gas turbine engine is disclosed. The system may include an inlet provided in a nacelle of a gas turbine engine. A first passage may communicate a flow of air from the inlet to a first engine component of the gas turbine engine and a second passage may communicate the flow of air from the inlet to a second engine component of the gas turbine engine.

In an embodiment, the multi stage air flow management system may further include an outlet passage communicating heated air from the first engine component to an outlet provided in a nacelle.

In a further embodiment, the second passage may communicate heated air from the first engine component to the second engine component.

In yet a further embodiment, the multi stage air flow management system may further include a third passage communicating the flow of air from the inlet to a third engine component of the gas turbine engine.

In another further embodiment, the multi stage air flow management system may further include a plurality of third passages. Each third passage may communicate the flow of air from the inlet to a separate engine component.

In another embodiment, the second passage may communicate heated air from the first engine component to the second engine component.

In a further embodiment, the multi stage air flow management system may further include a third passage communicating the flow of air from the inlet to a third engine component of the gas turbine engine.

In yet another embodiment, the first engine component may be an air-oil cooler.

In accordance with another aspect of the present disclosure, a gas turbine engine is disclosed. The engine may include a nacelle having an inner wall positioned around the gas turbine engine and an outer wall positioned around and spaced apart from the inner wall forming an air passage therebetween. The engine may further include a multi stage air flow management system having an inlet to allow air to flow through a first passage and a second passage. The first passage may communicate the flow of air to a first engine component of the gas turbine engine and the second passage may communicate the flow of air to a second engine component of the gas turbine engine.

In an embodiment, the inlet of the multi stage air flow management system may be positioned such that air enters the inlet form the air passage between the inner and outer walls.

In another embodiment, the inlet of the multi stage air flow management system may be positioned such that air enters the inlet from an atmosphere radially outside to the outer wall of the nacelle.

In a further embodiment, the multi stage air flow management system may further include a neck extending from the outer wall to the inner wall of the nacelle to allow the flow of air to flow from the inlet to the first passage and second passage.

In another embodiment, the multi stage air flow management system may further include an outlet provided in the nacelle and an outlet passage communicating a flow of air from the first engine component to the outlet.

In yet another embodiment, the second passage may communicate heated air from the first engine component to the second engine component.

In a further embodiment, the multi stage air flow management system may further include a third passage communicating the flow of air form the inlet of the multi stage air flow management system to a third engine component of the gas turbine engine.

In accordance with yet another aspect of the present disclosure, a method of supplying air to engine components of a gas turbine engine is disclosed. The method may include receiving a flow of air from outside of the engine through a first passage and a second passage. The method may further include cooling first engine component with the flow of air communicated by the first passage and communicating the flow of air to a second engine component of the gas turbine engine with the second passage.

In an embodiment, the method may further include heating the second engine component with heated air communicated by the second passage. The heated air may be received from the first engine component.

In a further embodiment, the method may further include receiving the flow of air from an inlet to a third engine component of the gas turbine engine by a third passage.

In another embodiment, the method may further include releasing heated air from the first engine component into an atmosphere through an outlet via an outlet passage.

In a further embodiment, the method may further include communicating the flow of air from an inlet to a plurality of engine components with a plurality of second passages.

These and other aspects and features of the present disclosure will be better understood in light of the following detailed description when read in light of the accompanying drawings.

### BRIEF DESCRIPTION OF THE DRAWINGS

FIG. 1 is a cross-sectional view of a gas turbine engine constructed in accordance with an embodiment of the present disclosure.

FIG. 2 is a cross-sectional view of another gas turbine engine constructed in accordance with another embodiment of the present disclosure.

FIG. 3 is a cross-sectional view of yet another gas turbine engine constructed in accordance with another embodiment of the present disclosure.

FIG. 4 is a cross-sectional view of still another gas turbine engine constructed in accordance with another embodiment of the present disclosure.

FIG. 5 is a schematic illustration of a first embodiment of a multi stage air flow management system constructed in accordance with an embodiment of the present disclosure.

FIG. 6 is a schematic illustration of a second embodiment of a multi stage air flow management system constructed in accordance with an embodiment of the present disclosure.

FIG. 7 is a schematic illustration of a third embodiment of a multi stage air flow management system constructed in accordance with an embodiment of the present disclosure.

FIG. 8 is a schematic illustration of a fourth embodiment of a multi stage air flow management system constructed in accordance with an embodiment of the present disclosure.

FIG. 9 is a schematic illustration of a fifth embodiment of a multi stage air flow management system constructed in accordance with an embodiment of the present disclosure.

FIG. 10 is a schematic illustration of a sixth embodiment of a multi stage air flow management system constructed in accordance with an embodiment of the present disclosure.

FIG. 11 is a schematic illustration of a seventh embodiment of a multi stage air flow management system constructed in accordance with an embodiment of the present disclosure.

It should be understood that the drawings are not necessarily to scale and that the disclosed embodiments are sometimes illustrated diagrammatically and in partial views. In certain instances, details which render other details difficult to perceive may have been omitted. It should be understood, of course, that this disclosure is not limited to the particular embodiments illustrated herein, but rather is to include all equivalents as well.

### DETAILED DESCRIPTION

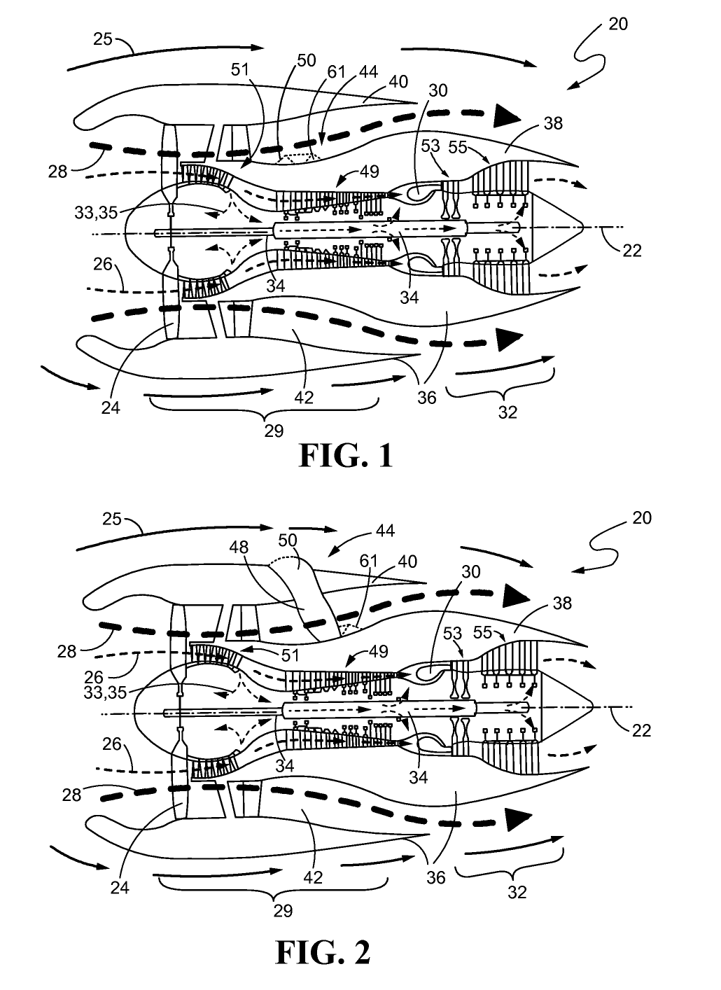

Referring now to the drawings, and with specific reference to FIGS. 1-4, a gas turbine engine is illustrated and generally indicated by reference numeral 20. As can be seen, the engine 20 includes a plurality of components axially aligned along a central axis 22. At a forward end of the engine 20 a fan 24 rotates to draw in and accelerate ambient air 25. This air is split into a core flow 26 and a bypass flow 28. The core flow 26 flows to a compressor section 29 where it is compressed. From the compressor section 29, the compressed core flow 26 travels to a combustor 30 where the core flow 26 is mixed with a fuel and combusted to form an exhaust. The exhaust expands through a turbine section 32 and exits the engine 20 at an aft end. As the exhaust expands, turbines of the turbine section 32 are rotated. This rotational motion is communicated to the fan 24 and compressor section 29 via an engine shaft 34, or plurality of engine shafts 34 in the case of a dual-spool engine 20 as shown.

Many gas turbine engines 20 also include a secondary flow path 33 and a tertiary flow 35 path to enable cooling air to be communicated throughout the engine 20. Typically, these flow paths 33, 35 receive a flow of bleed air from the compressor section 29 as also shown in FIGS. 1-4.

A nacelle 36 surrounds the engine 20 and includes an inner wall 38 immediately surrounding the engine 20, including the compressor section 29, combustor 30, and turbine section 32, and an outer wall 40, spaced apart from and surrounding the inner wall 38. The inner and outer walls 38, 40 cooperate to form an air passage 42. The bypass flow 28 travels along the air passage 42 from the fan 24 back into the atmosphere generating most of the thrust of the engine 20 in the process.

In the engine 20 of FIG. 1, a multi stage air flow management system 44 has been provided on the inner wall 38 to allow some of the bypass flow 28 to flow into the engine 20 as a cooling flow 46. Alternatively, as seen best in FIG. 2, the system 44 may be provided on the outer wall 40 to allow the ambient air 25 from radially outside the outer wall 40 to flow into the engine 20. In this configuration the system 44 includes a neck 48 extending between the inner and outer walls 38, 40 to allow the cooling flow 46 to flow from the inlet 50 at the exterior of the nacelle 36 to the engine 20. This second configuration depletes none of the bypass flow 28 while still supplying the cooling flow 46 to the engine 20.

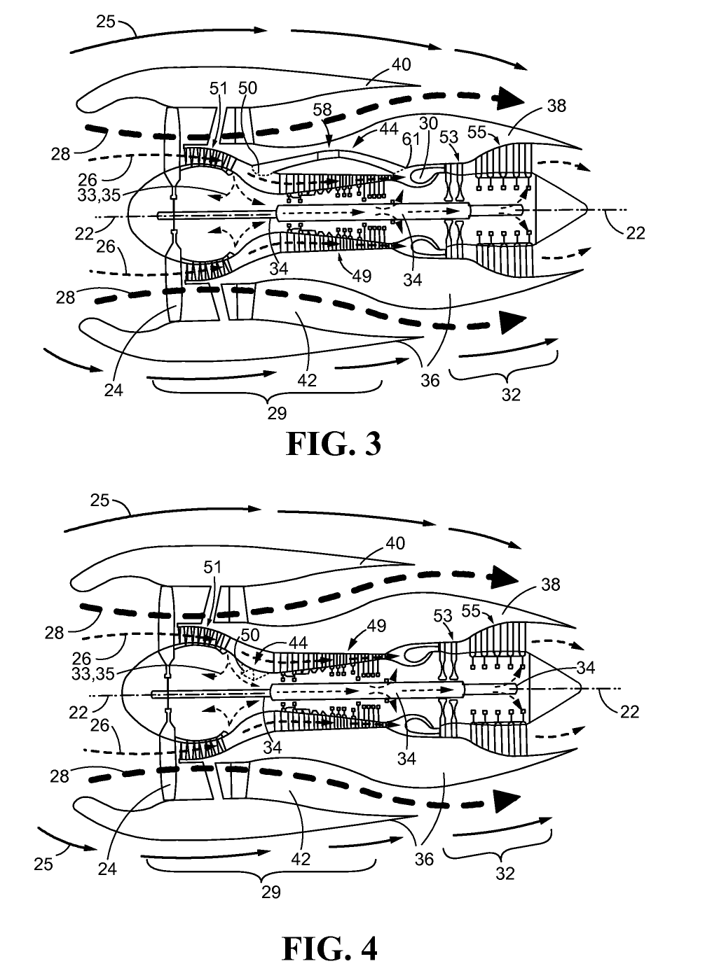

The engine of FIG. 3 illustrates a multi stage air flow management system 44 positioned to receive air from the core flow 26. While this embodiment presents the system 44 being positioned between a high pressure compressor 49 and a low pressure compressor 51 of the compressor section 29, this is not limiting and the system 44 may be positioned to receive air from the core flow 26 anywhere in the engine 20. The positioning of the system 44 may be chosen based upon a number of parameters such as, but not limited to, a temperature or a pressure of the air. If higher temperature air is desired, the system 44 may draw air from the high pressure compressor 51 or from the turbine section 32. For lower temperature air, the system 44 may draw air from the low pressure compressor 49. If higher pressure air is desired, the system 44 may draw air from the high pressure compressor 51 or from a high pressure turbine 53 of the turbine section 32, while for lower pressure air, the system 44 may draw air from the low pressure compressor 49 or a low pressure turbine 55 of the turbine section 32.

Turning now to the engine 20 depicted in FIG. 4, the multi stage air flow management system 44 is positioned to accept air from either the second or third flow paths 33, 35. While the system 44 is illustrated in a particular location in FIG. 4, it is to be understood that the system 44 may be positioned to accept air from anywhere along the second or third flow paths 33, 35. This positioning may be determined by space availability in the engine 20, temperature requirements for the air, pressure of the air, and the like. For example, for higher temperature air, the system 44 may be positioned to accept air from the second flow path 33 once the air has cooled multiple components positioned along the second flow path 33.

While the forgoing descriptions and FIGS. illustrate the multi stage air flow management system 44 positioned in and accepting air from a number of locations throughout the engine 20, these locations are not to be limiting. The system 44 may be positioned to receive air from any air flow path throughout the engine or from outside the engine 20, as in the case of the ambient air 25 in FIG. 2.

As is illustrated in the following figures, each of the multi stage air flow management systems 44 are characterized by an inlet 50 communicating a flow of air from a source external to the engine 20 such as from the bypass flow 28 or the ambient air outside of the outer wall 40 of the nacelle 36 to a first passage 52, or conduit, as the cooling flow 46. The first passage 52 communicates the cooling flow 46 from the inlet 50 to an air-oil cooler 54 of the engine 20, where the cooling flow 46 may be utilized to cool oil or another lubricant of the engine 20. In addition to the first passage 52, a second passage 56, or conduit, is also provided to communicate air to any number of engine components 58 such as, but not limited to a buffer, an oil tank, or a turbine case. From such components the air may be communicated to the core or bypass flow paths 26, 28 or other air flow paths of the engine 20. This flow of air from the second passage 56 may also be communicated to the secondary and/or tertiary flow paths 33, 35 to supplement the bleed air from the compressor section 29 or to completely replace this bleed air allowing for the previous bleed air to be used in the combustion process.

The term “engine component” 58 shall be used in reference to any component of the engine that requires or can benefit from cooling or heating by air. Additionally the core, bypass, secondary and tertiary flow paths 26, 28, 33, 35, as well as any other flow paths not mentioned herein, will also be encompassed by the term “engine component” 58.

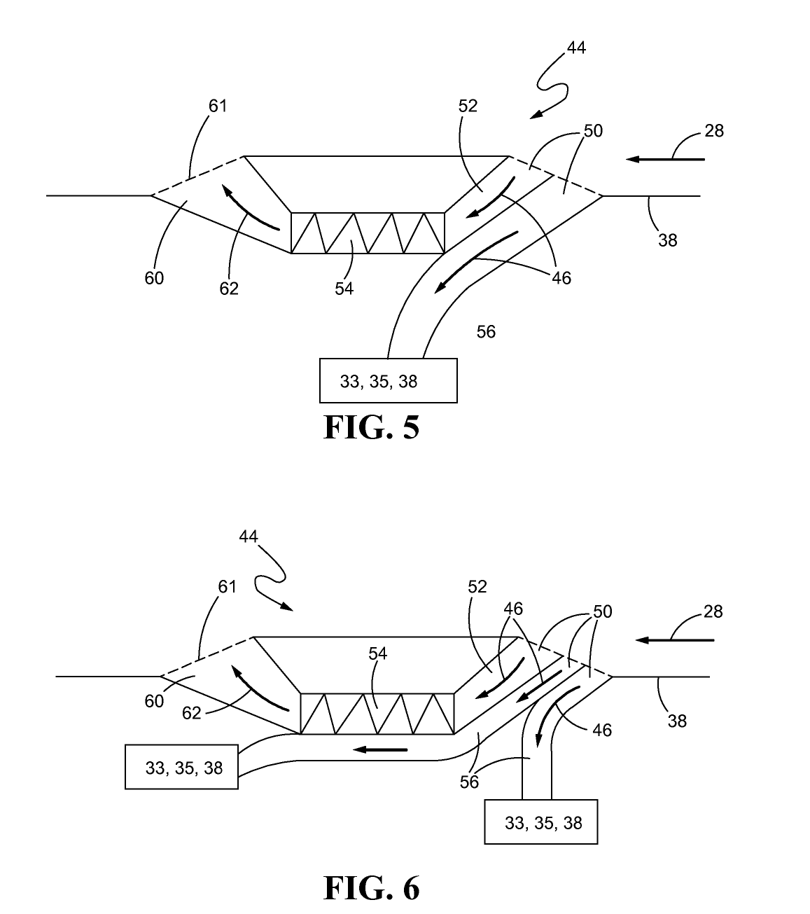

As illustrated in FIG. 5 an outlet passage 60 communicates a flow of heated air 62 from the air-oil cooler 54 to an outlet 61 where the air 62 is released into the bypass flow 28 traveling through the air passage 42. The second passage 56, in this embodiment, communicates the cooling flow 46 from the inlet 50 to the engine components 58. While only one second passage 56 is detailed in FIG. 5, any number of second passages 56 may be included to communicate the cooling flow 46 from the inlet 50 to any number of engine components 58. FIG. 6 is an illustration of a similar multi stage air flow management system 44 to that of FIG. 5 except there are multiple second passages 56, each second passage 56 communicates the cooling flow 46 to a separate engine component 58.

As can also be seen in FIGS. 5 and 6, the second passages 56 may be oriented in any desired direction such as, but not limited to, axially along the length of the engine 20, radially into the engine 20, or circumferentially about the engine 20. Each of these directions are described with respect to the central axis 22.

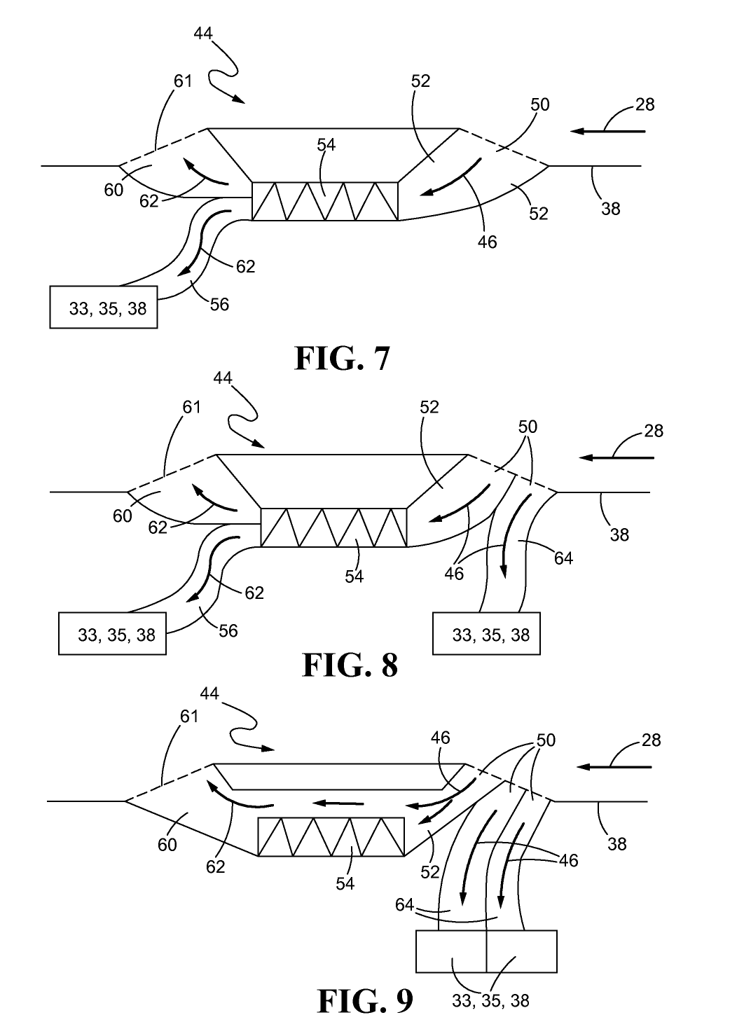

Turning now to FIG. 7, another embodiment of the multi stage air flow management system 44 is illustrated. In this embodiment, the second passage 56 communicates a portion of the heated air 62 from the air-oil cooler 54 to the engine components 58. Again, while only one second passage 56 is illustrated any number of second passages 56 may be provided. The system 44 of FIG. 7 also includes the outlet passage 60 and outlet 61 to communicate a portion of the heated air 62 back into the atmosphere via the bypass flow 28.

Additionally, as illustrated by a similar embodiment in FIG. 8, a third passage 64, or conduit, or a plurality of third passages 64, may also be provided to communicate the cooling flow 46 from the inlet 50 to the engine components 58. Such a configuration allows for both ambient air and heated air to be communicated to elements of the engine 20 by the multi stage air flow management system 44.

Another embodiment, illustrated in FIG. 9, includes the outlet passage 60 communicating the heated air 62 to the outlet 61 and back into the atmosphere via the bypass flow 28 traveling through the air passage 42 of the nacelle 36. The first passage 52, while communicating the cooling flow 46 to the air-oil cooler 54 as in previous embodiments, also bypasses the air-oil cooler 54 to communicate some of the cooling flow 46 directly to the outlet passage 60. The multi stage air flow management system 44 illustrated also includes multiple second passages 56 communicating the cooling flow 46 from the inlet 50 to engine components 58. While illustrated as having two second passages 56, this embodiment may include any number of second passages 56 communicating between the inlet 50 and the engine components 58.

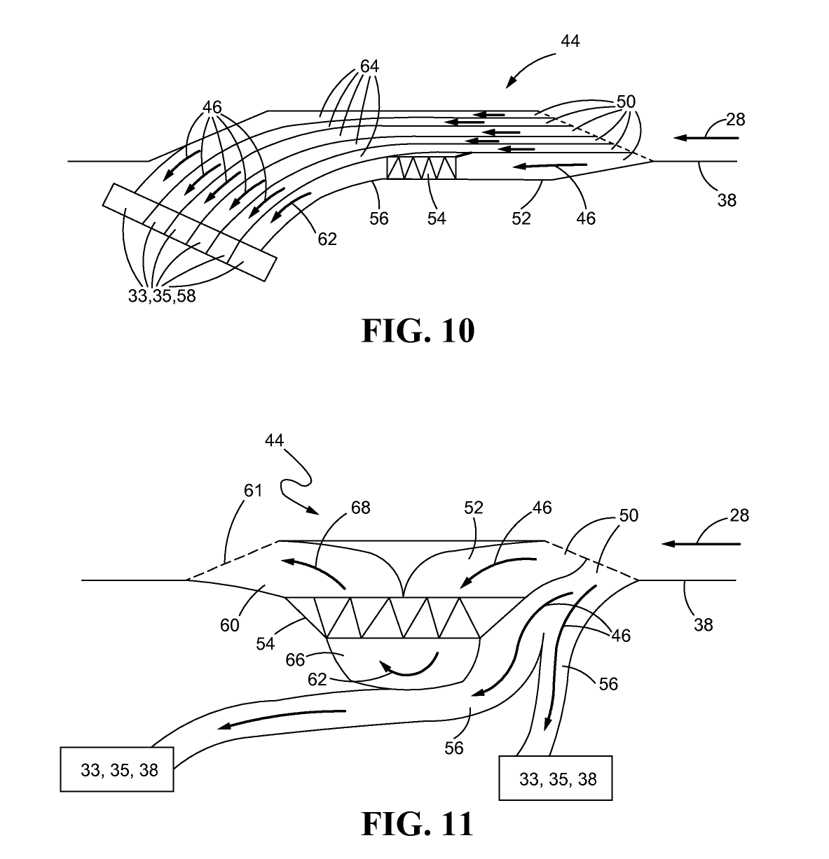

In yet another embodiment, illustrated in FIG. 10, the second passage 56 communicates the heated air 62 from the air-oil cooler 54 to engine components 58. Additionally, a plurality of third passages 64 communicate from the inlet 50 to the engine components 58. This embodiment does not immediately return the heated air 62 back to the atmosphere, and instead communicates the heated air 62 to elsewhere in the engine 20, where the heated air will be utilized and ultimately flow into the one of the flow paths 26, 28, 33, 35. Further, this embodiment also illustrates the third passages radially exterior to the first passage 52 and air-oil cooler 54. Similar positioning of the passages 56, 64 is also possible in other embodiments as well.

It can be seen in the embodiment illustrated in FIG. 11 that a single second passage 56 may communicate to multiple engine components 58. Further, as illustrated, the first passage 52 may communicate the cooling flow 46 to the air-oil cooler 54, as in all previous embodiments, but then an intermediate passage 66 may communicate heated air 62 away from the air-oil cooler 54 and then back again to be reused by the air-oil cooler 54. Finally, the now twice heated air 68 may be communicated to the outlet 61 and back into the atmosphere from the air-oil cooler 54 by the outlet passage 60.

While FIGS. 5-11 illustrate specific embodiments having unique features for that embodiment, unique positioning of elements of the system 44, or a set number of second and third passages 56, 64, this is in no way limiting and many of the features presented above are compatible with multiple embodiments. For example, any number of second and third passages 56, 64 may be included with each multi stage air flow management system 44 to communicate the cooling flow 46 and/or the heated air 62 to the engine components 58. Further, all the embodiments of FIGS. 5-11 detail systems 44 that have an inlet 50 located in the inner wall 38 of the nacelle 36, however each of the previously presented embodiments may be modified to have an inlet 50 in the outer wall 40 to allow ambient air from radially outside of the outer wall 40, with respect to the central axis 22, to flow into the multi stage air flow management system 44. This may be accomplished, for example, by including the neck 48, as illustrated in FIG. 2, extending from the outer wall 40 to the inner wall 38 which communicates the cooling flow 46 from the inlet 50 to the first, second, and/or third passages 52, 56, 64. The system 44 may also be modified to accept a flow of air from the core, second, or tertiary flow paths 26, 33, 35 as illustrated in FIGS. 3 and 4.

The multi stage air flow management system 44 may also be positioned within the engine 20 to bypass certain engine components 58 along a flow path already present in the engine 20. For example in FIG. 3, the inlet 50 of the system 44 may be positioned between the high and low pressure compressors 49, 51 to receive air from the core flow 26 while the outlet 61 of the system 44 may be positioned between the high pressure compressor 49 and the combustor 30. Such an arrangement would provide cooler and less pressurized air to combustor 30 directly, or to and engine component 58 and then to the combustor 30. Such an arrangement is purely exemplary, and should not be considered limiting in any way.

### INDUSTRIAL APPLICABILITY

From the foregoing, it can be seen that the technology disclosed herein has industrial applicability in a variety of settings such as, but not limited to supplying a flow of air from exterior of the engine or from a flow path inside the engine to any number of engine components, the core flow, the second flow path, and/or the tertiary flow path in a gas turbine engine. This flow of air may be cool air or heated air as desired. Such air flows provided by the auxiliary air flow intake may supplement or replace previous air flow sources such as, but not limited to, the bleed air from the compressor section or may provide a flow of air around and engine component in a particular flow path. Further, the presented auxiliary air flow intake may provide new cooling or heated flows to the engine components.

While the present disclosure has been made in reference to a gas turbine engine and an aircraft, and specifically to air flows provided to and from an air-oil cooler, one skilled in the art will understand that the teachings herein can be used in other applications as well such as, but not limited to, providing a cooling and/or a heated flow of air to any component of a gas turbine engine, aircraft, or other machine that requires or can benefit from such an air flow as well as providing a flow of air to any current or future air flow paths of the gas turbine engine, aircraft, or other machine. It is therefore intended that the scope of the invention not be limited by the embodiments presented herein as the best mode for carrying out the invention, but that the invention include all equivalents falling within the spirit and scope of the appended claims as well.

What is claimed is:

1. A multi stage air flow management system for a gas turbine engine, comprising:
an inlet provided in a nacelle of the gas turbine engine;
a first passage communicating a flow of air from the inlet to a first engine component of the gas turbine engine; and
a second passage communicating the flow of air from the inlet to a second engine component of the gas turbine engine.

2. The multi stage air flow management system of claim 1, further comprising an outlet passage communicating heated air from the first engine component to an outlet provided in a nacelle.

3. The multi stage air flow management system of claim 2, wherein the second passage communicates heated air from the first engine component to the second engine component.

4. The multi stage air flow management system of claim 3, further comprising a third passage communicating a flow of air from the inlet to a third engine component of the gas turbine engine.

5. The multi stage air flow management system of claim 1, further including a plurality of third passages, each third passage communicating the flow of air from the inlet to a separate engine component.

6. The multi stage air flow management system of claim 1, wherein the second passage communicates heated air from the first engine component to the second engine component.

7. The multi stage air flow management system of claim 6, further comprising a third passage communicating the flow of air from the inlet to a third engine component of the gas turbine engine.

8. The multi stage air flow management system of claim 1, wherein the first engine component is an air-oil cooler.

9. A gas turbine engine, comprising:
a nacelle including an inner wall positioned around the gas turbine engine, and an outer wall positioned around and spaced apart from the inner wall forming an air passage therebetween; and
a multi stage air flow management system having an inlet in the nacelle to allow air to flow through a first passage and a second passage, the first passage communicating the flow of air to a first engine component of the gas turbine engine and the second passage communicating the flow of air to a second engine component of the gas turbine engine.

10. The gas turbine engine of claim 9, wherein the inlet of the multi stage air flow management system is positioned such that air enters the inlet from the air passage between the inner and outer wall.

11. The gas turbine engine of claim 9, wherein the inlet of the multi stage air flow management system is positioned such that air enters the inlet from the atmosphere radially outside to the outer wall of the nacelle.

12. The gas turbine engine of claim 11, wherein the multi stage air flow management system further includes a neck extending from the outer wall to the inner wall of the nacelle to allow the flow of air to flow from the inlet to the first passage and second passage.

13. The gas turbine engine of claim 9, wherein the multi stage air flow management system further includes an outlet provided in the nacelle and an outlet passage communicating a flow of air from the first engine component to the outlet.

14. The gas turbine engine of claim 9, wherein the second passage communicates heated air from the first engine component to the second engine component.

15. The gas turbine engine of claim 14, wherein the multi stage air flow management system further includes a third passage communicating the flow of air from the inlet of the multi stage air flow management system to a third engine component of the gas turbine engine.

16. A method of supplying air to engine components of a gas turbine engine, comprising:
receiving a flow of air from outside of the engine through a first passage and a second passage;
cooling a first engine component of the gas turbine engine with the flow of air communicated by the first passage; and
communicating the flow of air to a second engine component of the gas turbine engine with the second passage.

17. The method of claim 16, further comprising heating the second engine component with heated air communicated by the second passage, the heated air received from the first engine component.

18. The method of claim 17, further comprising receiving the flow of air from an inlet to a third engine component of the gas turbine engine by a third passage.

19. The method of claim 16, further comprising releasing heated air from the first engine component into an atmosphere through an outlet via an outlet passage.

20. The method of claim 19, further comprising communicating the flow of air from an inlet to a plurality of engine components with a plurality of second passages.
